(19) United States
(12) Patent Application Publication
(10) Pub. No.: US 2015/0033809 A1
(43) Pub. Date: Feb. 5, 2015

(54) LOCKABLE LOCKING DEVICE FOR A VEHICLE SEAT, AND VEHICLE SEAT

(71) Applicant: KEIPER GmbH & Co. KG, Kaiserslautern (DE)

(72) Inventors: Peter Mueller, Mackenbach (DE); Bernd Heimann, Reiffelbach (DE); Kadir Yasaroglu, Güzelyali (TR)

(21) Appl. No.: 14/349,106

(22) PCT Filed: Oct. 26, 2012
(86) PCT No.: PCT/EP2012/004478

§ 371 Date: Apr. 2, 2014

(30) Foreign Application Priority Data
Nov. 4, 2011 (DE) 10 2011 117 973.2
Feb. 16, 2012 (DE) 10 2012 003 333.8

(51) Int. Cl. B60N 2/36; B60N 2/44

(52) U.S. Cl. CPC B60N 2/366; B60N 2/442; B60N 2002/4475
USPC 70/237

(57) ABSTRACT

A lockable locking device (1) for a vehicle seat (3) includes an unlocking handle (42) for unlocking the locking device (1) and a locking cylinder (50) for locking the locking device (1). The locking cylinder (50) is fastened to the unlocking handle (42). The unlocking handle (42) is substantially arranged within an unlocking housing (40) and is pivotable relative to the unlocking housing (40) about an unlocking axis (43). The locking cylinder (50) is configured approximately in the shape of a cylinder, wherein the cylinder axis (54) thereof runs in a plane perpendicularly to the unlocking axis (43). A vehicle seat (3) is provided with at least one such locking device (1).

### CROSS REFERENCE TO RELATED APPLICATIONS

This application is a United States National Phase Application of International Application PCT/EP2012/004478 filed Oct. 26, 2012 and claims the benefit of priority under 35 U.S.C. §119 of German Patent Application DE 10 2011 117 973.2 filed Nov. 4, 2011 and German Patent Application DE 10 2012 003 333.8 filed Feb. 16, 2012, the entire contents of which are incorporated herein by reference.

### FIELD OF THE INVENTION

The invention relates to a lockable locking device for a vehicle seat, in particular for a motor vehicle seat, including an unlocking handle for unlocking the locking device and a locking cylinder for locking the locking device, wherein the locking cylinder is fastened to the unlocking handle. The invention further relates to a vehicle seat comprising the locking device.

### BACKGROUND OF THE INVENTION

A generic locking device is disclosed in WO 2010/003587 A1. Such a locking device is used, in particular, in foldable backrests of rear seats in order to lock the backrest in an approximately upright position to the vehicle structure.

Locking devices are known from use, said locking devices being designed to be able to be locked by means of a locking cylinder. By locking the locking device by means of the locking cylinder, the locking device is prevented from being unlocked and, as a result, the backrest is prevented from being folded over. As a result, access to the luggage compartment from the passenger compartment is prevented and thus the lockability constitutes an anti-theft system.

In known lockable locking devices, the locking cylinder is inserted into a locking housing or into a cover of the locking device and drives a blocking element, for example a bolt which is displaceable in a linear manner. In its blocked position, the blocking element prevents a pivoting movement of the handle.

Such a locking device is disclosed, for example, in JP 2010-000 816 A.

A generic locking device is also disclosed in DE 44 01 061 A1, said locking device having a rotary handle part with a lever for unlocking A locking cylinder is inserted into the lever for locking the locking device.

In this case, the locking cylinder and the blocking element require a relatively large constructional space and the mounting of the locking device is relatively complex.

### SUMMARY OF THE INVENTION

The object of the invention is to improve a vehicle seat as well as a locking device of the type mentioned in the introduction, in particular to simplify the construction and mounting of the locking device and to reduce the required constructional space.

According to the invention, a lockable locking device for a vehicle seat comprises an unlocking handle for unlocking the locking device and a locking cylinder for locking the locking device, wherein the locking cylinder is fastened to the unlocking handle. The unlocking handle is substantially arranged within an unlocking housing and is pivotable relative to the unlocking housing about an unlocking axis and the locking cylinder is configured to be approximately cylindrical and in this case the cylinder axis thereof runs in a plane perpendicularly to the unlocking axis.

By means of the design according to the invention of the locking device, an additional blocking element is not required. The required constructional space is thus reduced and the mounting of the locking device is simplified. Moreover, by this arrangement the fastening of the locking cylinder to the unlocking handle is carried out relatively easily and the arrangement results in relatively easy operation of the unlocking handle by a user.

Advantageously, one end of the locking cylinder protrudes into the inside of the unlocking housing, whereby the required constructional space is further reduced.

It is also advantageous if the locking cylinder is pivotably arranged about the unlocking axis relative to the unlocking housing, whereby the design of the locking device is simplified.

In particular, the design is simplified if, when the unlocking handle pivots about the unlocking axis, the locking cylinder accordingly pivots therewith.

Preferably, in this case, the locking cylinder has a cam which is pivotable about the cylinder axis relative to the unlocking handle. Such a design further minimizes the required constructional space.

Preferably, in this case, the cam protrudes radially from the cylinder axis, whereby the cooperation with a stop provided therefor is facilitated.

Advantageously, at least one such stop is attached to the unlocking housing, with which the cam cooperates.

According to an advantageous development of the invention, the cam has two flanks which protrude radially from the cylinder axis and which cooperate with a stop and with an additional stop, wherein the stop and the additional stop are attached to the unlocking housing. By this design, when attempting to unlock the locking device in the locked state, i.e. in the blocked position of the cam, a uniform loading is applied to the cam and thus to the locking cylinder. One-sided loading which could lead to jamming of the cam or the locking cylinder is thereby avoided.

The stop and/or the additional stop are advantageously configured integrally with the unlocking housing. As a result, an additional mounting cost for fastening a separate stop and/or a separate additional stop is avoided.

The object is also achieved by a vehicle seat having the lockable locking device for a vehicle seat according to the invention.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a locking device;

FIG. 2 is a sectional view through the locking device perpendicular to the unlocking axis;

FIG. 3a is a sectional view through the locking device along the line III-III in FIG. 2 in the open position;

FIG. 3b is a sectional view through the locking device along the line III-III in FIG. 2 in the blocked position;

FIG. 4a is a semi-transparent perspective view of the locking device in the open position;

FIG. 4b is a semi-transparent perspective view of the locking device in the blocked position;

FIG. 5 is a schematic view of a vehicle seat;

FIG. 6a is an alternative embodiment of the cam in the open position; and

FIG. 6b is an alternative embodiment of the cam in the blocked position.

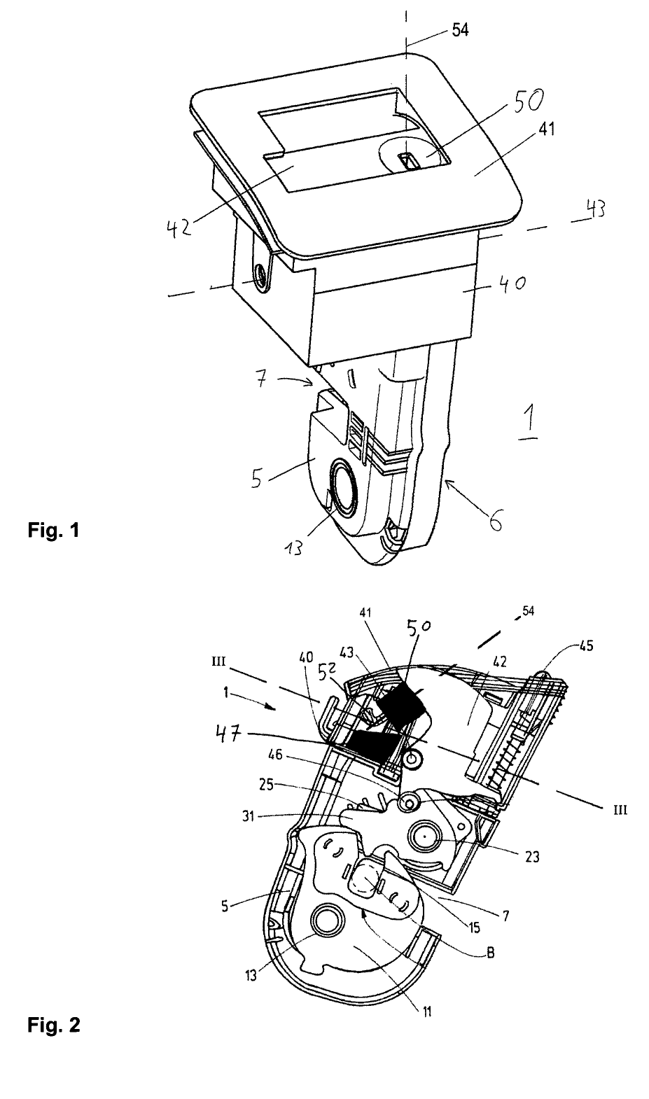

### DESCRIPTION OF THE PREFERRED EMBODIMENTS

Referring to the drawings in particular, a locking device 1 is provided, in a motor vehicle, for attaching a backrest 2 of a vehicle seat 3 to a vehicle structure. The locking device 1 has a lock housing 5 with an approximately planar bottom surface. The bottom surface is generally arranged in a plane defined by the direction of travel of the motor vehicle and by the vertical direction, which defines the directional information used hereinafter. The lock housing 5 is substantially closed by a lock cover 6 adjacent to the lock housing 5 and approximately parallel to the bottom surface. The lock housing 5 is preferably configured from plastics, optionally with an insert part made of a more solid material to increase the strength, whilst the lock cover 6 is preferably a sheet metal part.

The lock housing 5 and the lock cover 6 form a receiver 7 which opens in the direction of a counter element B, in order to receive said counter element for locking. In the present case, the locking device 1 is fastened to the backrest 2 and the counter element B is fastened to the vehicle structure. It is also conceivable for the locking device 1 to be fastened to the vehicle structure and the counter element B to be fastened to the backrest 2. In the present case, the counter element B is a pin. The portion of the counter element B receiving the receiver 7 generally extends horizontally.

A pawl 11 is pivotably mounted on a first bearing pin 13 which in turn is fastened to the lock housing 5 and to the lock cover 6 and protrudes vertically from the bottom surface thereof, i.e. extends horizontally. In the present case, the preferably metal first bearing pin 13 is riveted to the lock housing 5 and caulked to the lock cover 6. The first bearing pin 13 is preferably of hollow configuration in order to receive a fastening means, for example a screw, by means of which the locking device 1 is fastened when mounted on the backrest 2. The pawl 11 has a hooked recess 15 for cooperating with the counter element B.

A clamping element 25 is pivotably mounted on a second bearing pin 23 which is arranged parallel to the first bearing pin 13, said clamping element being pretensioned toward the pawl 11. In the locked state, the clamping element 25 as a securing element exerts a locking moment on the pawl 11.

A capture element 31 is arranged on the second bearing pin 23 axially adjacent to the clamping element 25 on the side remote from the lock cover 6 and is also pivotably mounted on the second bearing pin 23, i.e. aligned with the clamping element 25.

The capture element 31 and the clamping element 25 are coupled for entrainment with free travel, for example by means of a slot-pin guide or an axially protruding drive element. In the event of a crash, if the pawl 11 were to be subjected to an opening moment and slightly push away the clamping element 25, the capture element 31 serves for supporting the pawl 11 and as a further securing element prevents a further opening moment from being able to be transmitted to the pawl 11, and thus prevents an opening of the pawl 11.

The locking device 1 also comprises an unlocking housing 40 which is configured separately and is fastened to the upper end of the lock housing 5 and the lock cover 6.

The unlocking housing 40 is substantially configured as a shaft within which an unlocking handle 42 is arranged and in the present case is accessible from above. The unlocking handle 42 is mounted in the unlocking housing 40, manually pivotable about an unlocking axis 43 parallel to the bearing pin 13, 23.

The unlocking housing 40 is covered at the top by a cover 41 which has an opening through which the unlocking handle 42 is visible and actuatable.

Resiliently coupled to the unlocking handle 42 is an indicator 45 which is longitudinally displaceably guided in the unlocking housing 40 and is able to extend partially therefrom in order to display the unlocked state of the locking device 1. The purpose of the resilient coupling of the indicator 45 is to avoid damage to the extended indicator 45 in the event of misuse. The resilient coupling is implemented by means of a spring, by means of which the unlocking handle 42 activates and extends the indicator 45. For retracting the indicator 45, i.e. for displaying the locked state of the locking device 1, a positive contact is provided between the indicator 45 and the unlocking handle 42. The indicator 45 is at least partially colored in a signal color, in the present case red, which preferably clearly differs from the color of the unlocking housing 40 of the cover 41 thereof, in the present case black.

The unlocking handle 42 at its lower end has an actuating element 46 which acts in an articulated manner on the capture element 31.

In the locked state of the locking device 1 which is shown in FIG. 2, the counter element B is located in the receiver 7 and in the hooked recess 15 of the locked pawl 11. The clamping element 25 secures the pawl 11, the capture element 31 is slightly spaced apart from the pawl 11, the unlocking handle 42 is in its initial position and the indicator 45 is retracted.

If the unlocking handle 42 is pivoted about the unlocking axis 43, the indicator 45 is extended and the actuating element 46 pivots the capture element 31. The capture element 31 entrains the clamping element 25 so that the pawl 11 is no longer secured. Entrained by one of the two securing elements 25, 31, or by its own pretensioning, for example by a spring, the pawl 11 opens. Due to the pivoting movement of the pawl 11, the hooked recess 15 is pulled back from the receiver 7 and releases the counter element B which then moves away relative to the locking device 1.

A locking cylinder 50 is positively inserted in the unlocking handle 42. The locking cylinder 50 in the present case has an approximately cylindrical base body, the cylinder axis thereof 54 extending in a plane perpendicular to the unlocking axis 43. The locking cylinder 50 is thus of approximately cylindrical design.

A circular opening and a collar extending around said opening are provided in the unlocking handle 42, in which the locking cylinder 50 is positively retained by a clip connection. The locking cylinder 50 is fixed in the unlocking handle 42 in a manner which is fixed in terms of rotation and not displaceable.

The locking cylinder 50 is able to be actuated by means of a suitable key. To this end, the locking cylinder 50 comprises a keyhole which is located at the end of the locking cylinder 50 which is adjacent to the unlocking handle 42. The keyhole is arranged such that the key is able to be inserted into the keyhole in the direction of the cylinder axis 54 through the aperture provided in the cover 41.

A cam 52 is provided at the end of the locking cylinder 50 protruding into the inside of the unlocking housing 40, said end being remote from the unlocking handle 42, and said cam protruding in the radial direction from the cylinder axis 54.

When actuating the locking cylinder 50 by means of a key, i.e. when rotating the key inserted into the keyhole about the cylinder axis 54, the cam 52 also pivots about the cylinder axis 54 and namely by the same pivoting angle as the key.

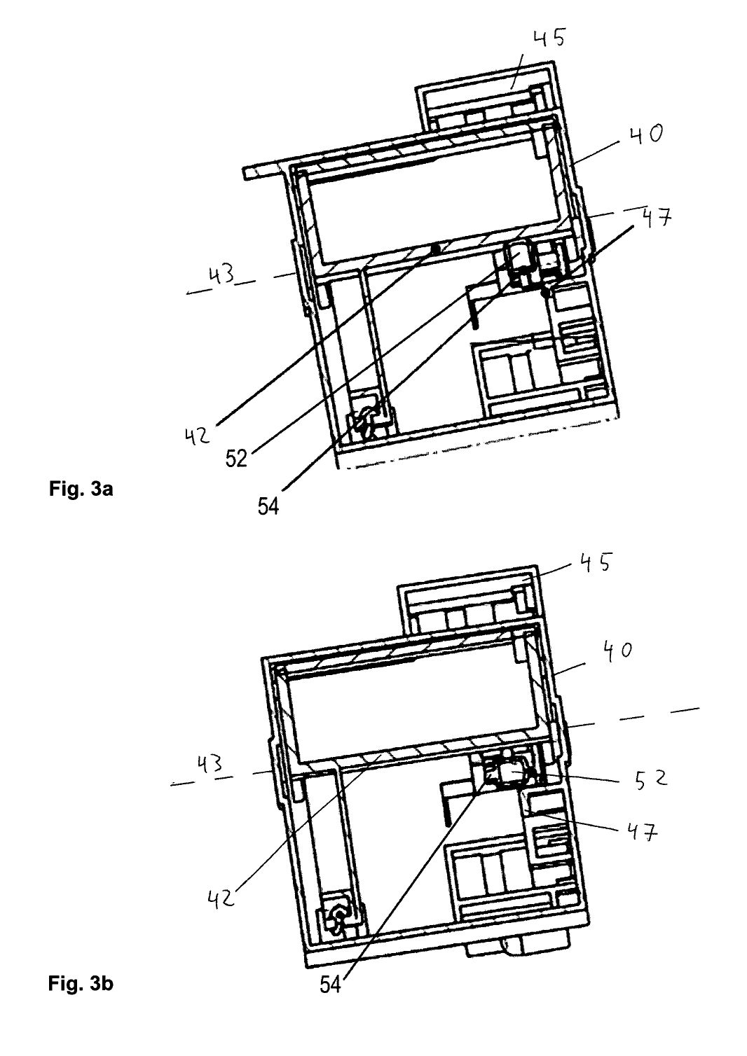

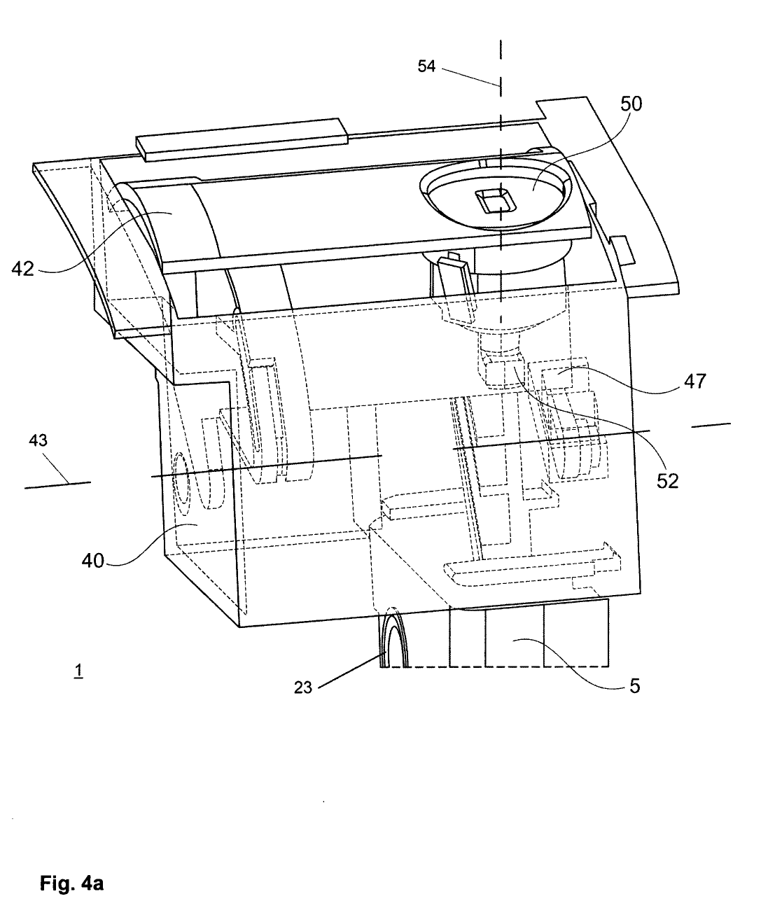

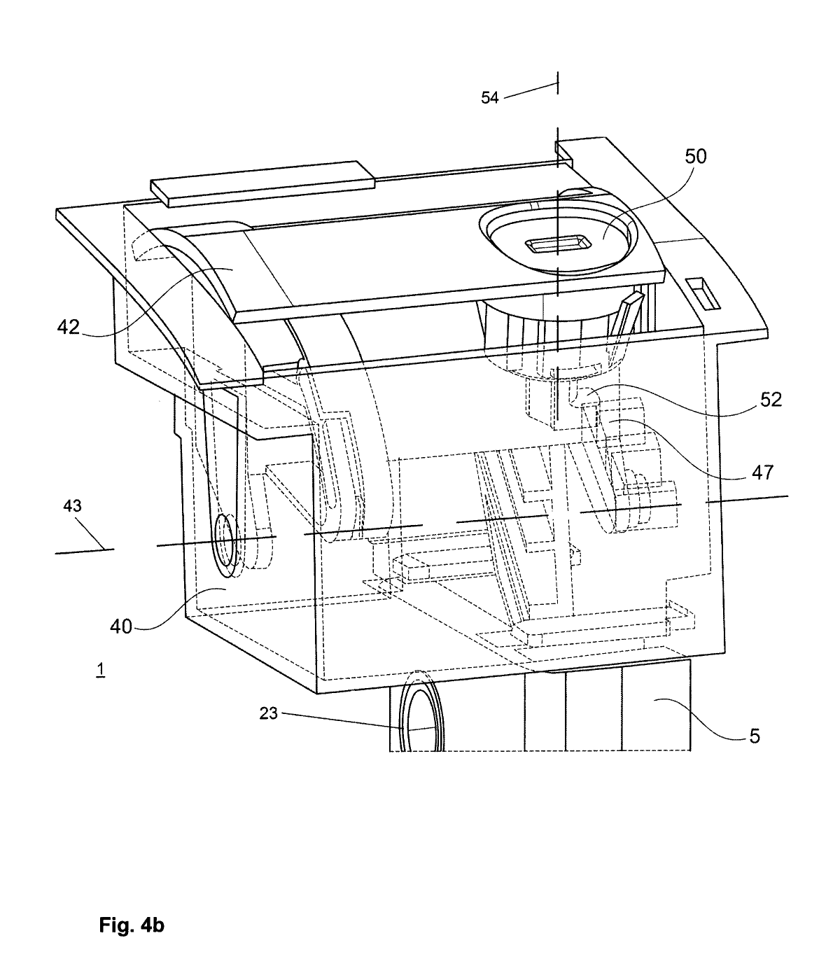

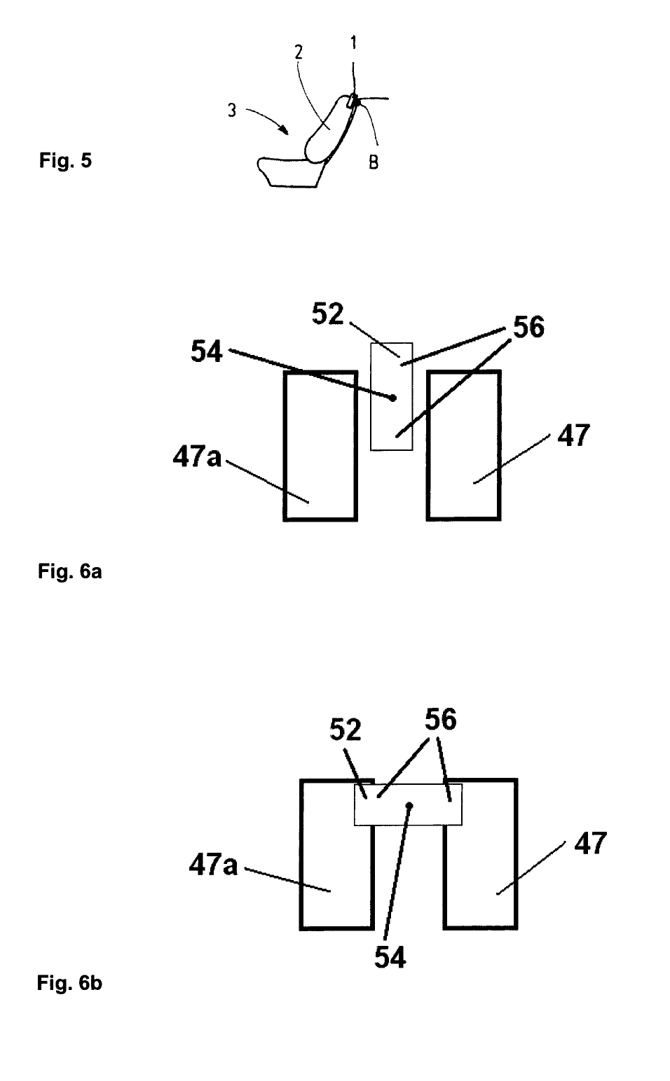

In this case, the cam 52 is pivotable between an open position shown in FIG. 3a and FIG. 4a and a blocked position shown in FIG. 3b and FIG. 4b. In the present case there is a pivoting angle of approximately 90° between the blocked position and the open position of the cam 52.

A stop 47 is attached to the unlocking housing 40 on the inside, said stop cooperating with the cam 52. The stop 47 in the present case is integrally configured with the unlocking housing 40. It is also conceivable to design the stop 47 as a separate component and to connect said stop to the unlocking housing 40, for example by means of a clip connection or a screw connection.

If the unlocking handle 42 is pivoted by a user about the unlocking axis 43, the locking cylinder 50 accordingly pivots with the cam 52.

In the blocked position of the cam 52, when the unlocking handle 42 is pivoted, the cam 52 strikes the stop 47, whereby a further pivoting of the unlocking handle 42 and thus an unlocking of the locking device 1 is not possible. If the cam 52 is in the blocked position, the locking device 1 is locked. Thus an unlocking of the locking device 1 is prevented.

In the open position of the cam 52, the cam 52 pivots past the stop 47 whereby a further pivoting of the unlocking handle 42 and thus an unlocking of the locking device 1 is possible. If the cam 52 is in the open position, the locking device 1 is not locked. Thus an unlocking of the locking device 1 is possible.

In the blocked position of the cam 52 and in the open position of the cam 52 the key is able to be inserted into the keyhole of the locking cylinder 50 and able to be removed from the keyhole of the locking cylinder 50. In the views according to FIG. 4a and FIG. 4b, in each case, the key is removed from the keyhole.

In an alternative embodiment which is shown in FIG. 6a and FIG. 6b, the cam 52 comprises two flanks 56 which protrude radially from the cylinder axis 54 of the locking cylinder 50 in diametrically opposing directions.

The views according to FIG. 6a and FIG. 6b, are in each case a plan view of a part of the locking device from above, wherein the cover, the unlocking handle and the cylindrical base body of the locking cylinder are not shown.

In this alternative embodiment, as well as the stop 47, an additional stop 47a is provided on the unlocking housing 40 on the inside, said additional stop also cooperating with the cam 52. In the present case, the additional stop 47a is integrally configured with the unlocking housing 40. It is, however, also conceivable to design the additional stop 47a as a separate component and to connect said stop to the unlocking housing 40, for example by means of a clip connection or a screw connection.

In this case, the stop 47 and the additional stop 47a are arranged such that, when the unlocking handle 42 is pivoted, the cam 52 is able to pivot in its open position shown in FIG. 6a between the stop 47 and the additional stop 47a. As a result, a further pivoting of the unlocking handle 42 and thus an unlocking of the locking device 1 is possible. The locking device 1 is thus not locked.

In this case, the stop 47 and the additional stop 47a are naturally arranged such that the cylindrical base body of the locking cylinder 50 is also able to pivot between the stop 47 and the additional stop 47a.

In its blocked position shown in FIG. 6b, when the unlocking handle 42 pivots about the unlocking axis 43, one of the flanks 56 of the cam 52 strikes the stop 47 and the other flank 56 of the cam 52 strikes the additional stop 47a. As a result, a further pivoting of the unlocking handle 42 and thus an opening of the locking device 1 is prevented. The locking device 1 is thus locked.

If the unlocking handle 42 is pivoted when the locking device 1 is locked, a uniform loading is applied to the cam 52 and thus to the locking cylinder 50. ‘Uniform’ means in this case that the loading is introduced at least approximately symmetrically to the cylinder axis 54 on both flanks 56 of the cam 52.

In this exemplary embodiment, the unlocking handle 42 is always operatively connected to the pawl 11. By locking the locking cylinder 50, a movement of the unlocking handle 42 is blocked. In an alternative exemplary embodiment, the locking handle 42 is coupled and operatively connected to the pawl 11 by means of the locking cylinder 50. By locking the locking cylinder 50, the coupling present between the locking handle 42 and the pawl 11 is interrupted so that the locking handle 42 remains movable but does not drive the pawl 11.

The features disclosed in the present description, the claims and the drawings may be significant both individually and in combination for implementing the invention in its various embodiments.

While specific embodiments of the invention have been shown and described in detail to illustrate the application of the principles of the invention, it will be understood that the invention may be embodied otherwise without departing from such principles.

1. A lockable locking device for a vehicle seat, the locking device comprising
an unlocking handle for unlocking the locking device; and
a locking cylinder for locking the locking device, wherein the locking cylinder is fastened to the unlocking handle, wherein the unlocking handle is substantially arranged within an unlocking housing and is pivotable relative to the unlocking housing about an unlocking axis, and the locking cylinder is configured to be approximately cylindrical, wherein a cylinder axis of the locking cylinder runs in a plane perpendicular to the unlocking axis.

2. The locking device as claimed in claim 1, wherein one end of the locking cylinder protrudes into the inside of the unlocking housing.

3. The locking device as claimed in claim 1, wherein the locking cylinder is pivotable about the unlocking axis relative to the unlocking housing.

4. The locking device as claimed in claim 3, wherein when the unlocking handle pivots about the unlocking axis, the locking cylinder accordingly pivots therewith.

5. The locking device as claimed in claim 1, wherein the locking cylinder has a cam which is pivotable about the cylinder axis relative to the unlocking handle.

6. The locking device as claimed in claim 5, wherein the cam protrudes radially from the cylinder axis.

7. The locking device as claimed in claim 5, wherein the cam cooperates with at least one stop which is attached to the unlocking housing.

8. The locking device as claimed in claim 5, wherein the cam has two flanks which protrude radially from the cylinder axis and which cooperate with a stop and with an additional stop which are attached to the unlocking housing.

9. The locking device as claimed in claim 8, wherein the stop and/or the additional stop are configured integrally with the unlocking housing.

10. A vehicle seat comprising at least one locking device for the vehicle seat the locking device comprising:
an unlocking handle for unlocking the locking device; and
a locking cylinder for locking the locking device, wherein the locking cylinder is fastened to the unlocking handle and wherein the unlocking handle is substantially arranged within an unlocking housing and is pivotable relative to the unlocking housing about an unlocking axis, and wherein the locking cylinder is configured to be approximately cylindrical, wherein a cylinder axis of the locking cylinder runs in a plane that is perpendicular to the unlocking axis.

11. The vehicle seat as claimed in claim 10, wherein one end of the locking cylinder protrudes into the inside of the unlocking housing.

12. The vehicle seat as claimed in claim 10, wherein the locking cylinder is pivotable about the unlocking axis relative to the unlocking housing.

13. The vehicle seat as claimed in claim 12, wherein when the unlocking handle pivots about the unlocking axis, the locking cylinder accordingly pivots therewith.

14. The vehicle seat as claimed in claim 10, wherein the locking cylinder has a cam which is pivotable about the cylinder axis relative to the unlocking handle.

15. The vehicle seat as claimed in claim 14, wherein the cam protrudes radially from the cylinder axis.

16. The vehicle seat as claimed in claim 14, wherein the cam cooperates with at least one stop which is attached to the unlocking housing.

17. The vehicle seat as claimed in claim 14, wherein the cam has two flanks which protrude radially from the cylinder axis and which cooperate with a stop and with an additional stop which are attached to the unlocking housing.

18. The vehicle seat as claimed in claim 17, wherein the stop and/or the additional stop are configured integrally with the unlocking housing.
